(19) United States
(12) Patent Application Publication
(10) Pub. No.: US 2007/0154745 A1
(43) Pub. Date: Jul. 5, 2007

(54) Purging a fuel cell system

(76) Inventor: Michael Penev, Albany, NY (US)

Correspondence Address: TROP PRUNER & HU, PC, 1616 S. VOSS ROAD, SUITE 750, HOUSTON, TX, 77057-2631, US

(21) Appl. No.: 11/400,499

(22) Filed: Apr. 7, 2006

Related U.S. Application Data
(60) Provisional application No. 60/754,725, filed on Dec. 29, 2005.

(51) Int. Cl. H01M 8/04

(52) U.S. Cl. 429/13; 429/22

(57) ABSTRACT

A technique to shut down a fuel cell system includes halting a fuel flow to a fuel cell stack of the fuel cell system. The technique includes subsequently flowing steam through fuel passageways of the fuel cell system to purge fuel from the system.

This application claims the benefit pursuant to 35 U.S.C. § 119(e) to U.S. Provisional Patent Application Ser. No. 60/754,725, entitled “PURGING A FUEL CELL SYSTEM,” filed on Dec. 29, 2005

### BACKGROUND

The invention generally relates to purging a fuel cell system.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system may include a cooling subsystem, a cell voltage monitoring subsystem, a control subsystem, a power conditioning subsystem, etc. The particular design of each of these subsystems is a function of the application that the fuel cell system serves.

Care must be exercised in shutting down a fuel cell stack for such purposes of preventing thermal combustion (due to potential hydrogen and oxygen mixing); preventing damage to the membranes of the fuel cell stack; and preventing corrosion/oxidation of components, such as preventing the corrosion of the cathode electrode.

Thus, there exists a continuing need for better ways to shut down a fuel cell system.

### SUMMARY

In an embodiment of the invention, a technique to shut down a fuel cell system includes halting a fuel flow to a fuel cell stack of the fuel cell system. The technique includes subsequently flowing steam through fuel passageways of the fuel cell system to purge fuel from the system.

In another embodiment of the invention, a fuel cell system includes a fuel cell stack, fuel passageways and a control subsystem. The control subsystem is adapted to shut down the fuel cell system by halting a fuel flow to the fuel cell stack and subsequently flowing steam through the fuel passageways to purge fuel from the system.

Advantages and other features of the invention will become apparent from the following drawing, description and claims.

### BRIEF DESCRIPTION OF THE DRAWING

FIGS. 1 and 4 are schematic diagrams of fuel cell systems according to different embodiments of the invention.

FIGS. 2, 3, 5 and 6 are flow diagrams depicting different techniques to shut down the fuel cell system according to different embodiments of the invention.

### DETAILED DESCRIPTION

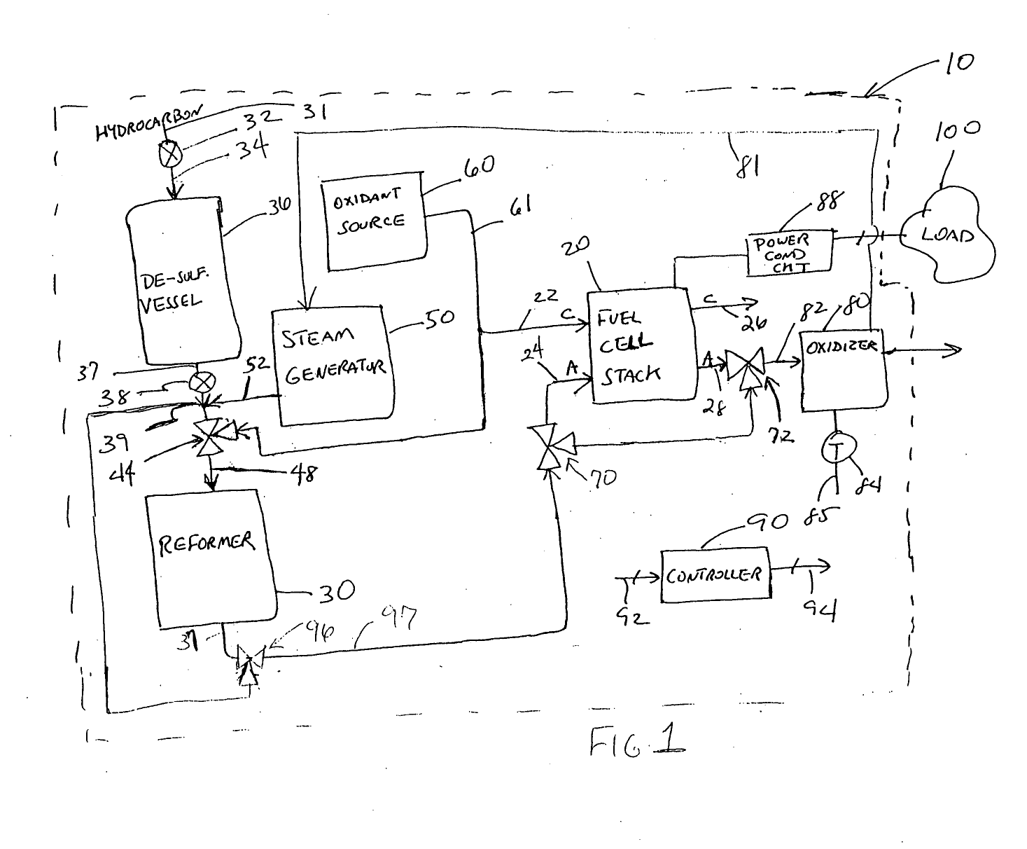

Referring to FIG. 1, a fuel cell system 10 in accordance with embodiments of the invention, uses steam to purge its fuel passageways during the shut down of the system 10.

The fuel cell system 10 includes a fuel cell stack 20 that produces electrical power for an external load 100 to the system 10. The load 100 may be an AC or a DC load, depending on the particular embodiment of the invention. During its normal mode of operation, the fuel cell stack 20 receives an incoming fuel flow at an anode inlet 24 of the stack 20 and receives an incoming oxidant flow at a cathode inlet 22 of the stack 20.

In accordance with some embodiments of the invention, the fuel cell stack 20 may be formed from PEM fuel cells, although other types of fuel cells are possible in other embodiments of the invention. In general, the fuel cells may be, for example, in the operating range of 30° C. to 850° C. (solid oxide fuel cells run as high as 850°), ranging from PEM to molten carbonate fuel cells.

The incoming fuel flows through the reformer and anode of the fuel cell stack 20 and exits the stack 20 at an anode exhaust outlet 28. Subsequently, it enters the fuel side of the burner prior to oxidation. In the context of this application, the phrase “anode side” refers to all areas where fuel/steam/air mix is in a ratio with less-than stoichiometric air (reformer, fuel cell anode channels, and burner fuel channels). The incoming oxidant to the fuel cell stack 20 flows through the cathode side of the fuel cell stack 20 and exits the stack 20 at a cathode exhaust outlet 26. In the context of this application, the language “cathode side” refers to the cathode inlet plenum passageway, the cathode flow channels and the cathode outlet plenum passageway of the stack 20.

In response to the fuel and oxidant flows during its normal mode of operation (i.e., the mode in which the fuel cell stack 20 is not being started up or shut down), the fuel cell stack 20 produces electrical power that is transformed into the appropriate form for the load 100 by power conditioning circuitry 88 of the fuel cell system 10. If the load 100 is a DC load, then the power conditioning circuitry 88 regulates the DC stack voltage that is provided by the fuel cell stack 20 into the appropriate DC level for the load 100. If the load 100 is an AC load, then the power conditioning circuitry 88 may include an inverter that converts the DC stack voltage into the appropriate AC voltage level for the load 100. Thus, many variations are possible and are within the scope of the appended claims.

In accordance with some embodiments of the invention, the fuel flow to the fuel cell stack 20 is reformate that is furnished by a reformer 30. In this regard, the reformer 30, in accordance with some embodiments of the invention, produces the reformate in response to an incoming hydrocarbon flow. For example, liquid propane gas may be received into the fuel cell system 10 and converted into the reformate by the reformer 30.

In accordance with some embodiments of the invention, the fuel cell system 10 includes a de-sulfurization vessel 36 that, as it name implies, includes a reactant bed that removes sulfur from an incoming liquid propane gas that is received at an inlet 34 of the vessel 36. The sulfur may be originally added to the liquid propane gas for safety reasons but is removed due to the potential harmful effects that may otherwise occur to components of the fuel cell system 10. Thus, due to the vessel 36, an outlet 37 of the de-sulfurization vessel 36 provides liquid propane gas that has a significantly reduced sulfur content. This flow is humidified at a mixing point 39 by water steam that is provided (at its outlet 52) by a steam generator 50. The resultant humidified liquid propane gas flow is then received at an inlet 48 of the reformer 30. This catalyst could in some embodiments also be purged with air (for example, some hydro-desulfurization techniques).

The oxidant flow to the fuel cell stack 20 may be provided by an oxidant source 60, such as an air blower, for example. Thus, an outlet 61 of the oxidant source 60 is in fluid communication with the cathode inlet 22 of the fuel cell stack 20.

In accordance with other features of the fuel cell system 10, in some embodiments of the invention, the fuel cell system 10 includes an oxidizer 80 that is in fluid communication with the anode exhaust outlet 28 of the fuel cell stack 20 for purposes of reducing emissions from the fuel cell system 10. An exhaust line 81 of the oxidizer may be routed back to the steam generator 50 for purposes of supplying thermal energy to generate steam. The steam generator 50 may, for example, include a heat exchanger to communicate the thermal energy from the oxidizer's exhaust to the steam that exits the generator 50. The fuel cell system 10 also includes a controller 90. The controller 90 may include one or more microprocessors and/or microcontrollers, depending on the particular embodiment of the invention. The controller 90 includes various input terminals 92 that receive status signals, sensed voltages and currents, commands, etc., depending on the particular embodiment of the invention. In response to the signals that are received at the input terminals 92, the controller 90 produces various output signals on its output terminals 94. These output signals, in turn, may control various components of the fuel cell system 10, such as motors, generators, valves, solenoids, switches, etc., depending on the particular embodiment of the invention. Furthermore, the output signals may indicate a particular command for a component of the fuel cell system 10, as well as a communication for an entity outside of the fuel cell system 10. Thus, many variations are possible and are within the scope of the appended claims.

Among its other functions, the controller 90 forms part of a control subsystem to not only regulate operation of the system 10 during the normal operation of the system 10 but also control the system 10 to shut down the system 10, as further described below. In this regard, the control subsystem may also include various valves, which, as described below, are operated by the controller 90 to purge fuel passageways of the system 10 with steam during the shut down of the system 10. The fuel passageways may include flow paths through the reformer 30, oxidizer 80 and possibly the anode side of the fuel cell stack 20, as further described below.

The valves that are used during the shut down of the fuel cell system 10 include, for example, a valve 32 that controls communication between a hydrocarbon flow inlet 31 and an inlet 34 of the de-sulfurization vessel 36 and a valve 38 that controls fluid communication between the outlet 37 of the de-sulfurization vessel 36 and the mixing point 39.

The fuel cell system 10 also includes various three-way valves, such as a three-way valve 44 that controls when oxidant is used to purge the fuel cell system 10. More specifically, during the normal mode of operation of the fuel cell system 10 and when the fuel cell system 10 is using steam to purge the system 10, the valve 44 is configured to establish communication between the mixing point 39 and the inlet 48 of the reformer 30. When, however, air is being used to purge the system 10, the valve 44 is re-configured to shut off communication between the mixing point 39 and the inlet 48 of the reformer 30 and establish communication between the outlet 61 of the oxidant source 60 and the inlet 48 of the reformer 30.

The fuel cell system 10 may also include three-way valves 70 and 72, which are used to selectively bypass the anode side of the fuel cell stack 20. In this regard, as depicted in FIG. 1, the three-way valve 70 is connected between the outlet of the reformer 30 and the anode inlet 24 of the fuel cell stack 20 such that when the fuel cell stack 20 is not in its bypass mode, the valve 70 permits fluid communication between the outlet of the reformer 30 and the anode inlet 24 and does not permit any bypass of the anode side. However, when the fuel cell stack 20 is placed in its bypass mode, the valve 70 establishes a bypass path by blocking communication between the outlet of the reformer 30 and the anode inlet 24 and establishing fluid communication between an outlet 37 of the reformer 30 and the three-way valve 72. The three-way valve 72, in turn, is configured to establish fluid communication between the anode exhaust outlet 28 and the inlet 82 of the oxidizer 80 during the non-bypass mode of the fuel cell stack 20. When the fuel cell stack 20 is placed in its bypass mode, the valve 72 is configured to establish fluid communication between the inlet 82 of the oxidizer 80 and the outlet of the reformer 30 and block communication between the anode exhaust outlet 28 and the outlet of the reformer 30. Thus, in the bypass mode, the outlet of the reformer 30 bypasses the anode side of the fuel cell stack 20 and is instead routed directly to the inlet 82 of the oxidizer 80.

The control subsystem of the fuel cell system 10 for controlling the system shut down may also include sensors. For example, for purposes of determining when fuel has been purged from the oxidizer 80, in accordance with some embodiments of the invention, the fuel cell system 10 includes a temperature sensor 84 that provides an indication (via its output terminal 85) of the temperature of the oxidizer 80. When the temperature of the oxidizer 80 decreases below a predetermined temperature threshold (which indicates that fuel has been significantly purged from the system 10) then the controller 90 shuts down the components of the system 10 to complete the shut down.

In accordance with some embodiments of the invention, the fuel cell system 10 may also include a three-way valve 96 for purposes of selectively bypassing the reformer 30. This arrangement allows the incoming fuel flow to bypass the reformer 30 and be routed to the oxidizer 80 when the reformer 30 is shut down. This allows, for example, thermal energy to be continued to be supplied by the oxidizer 80 to the steam generator 50 after the shut down of the reformer 30.

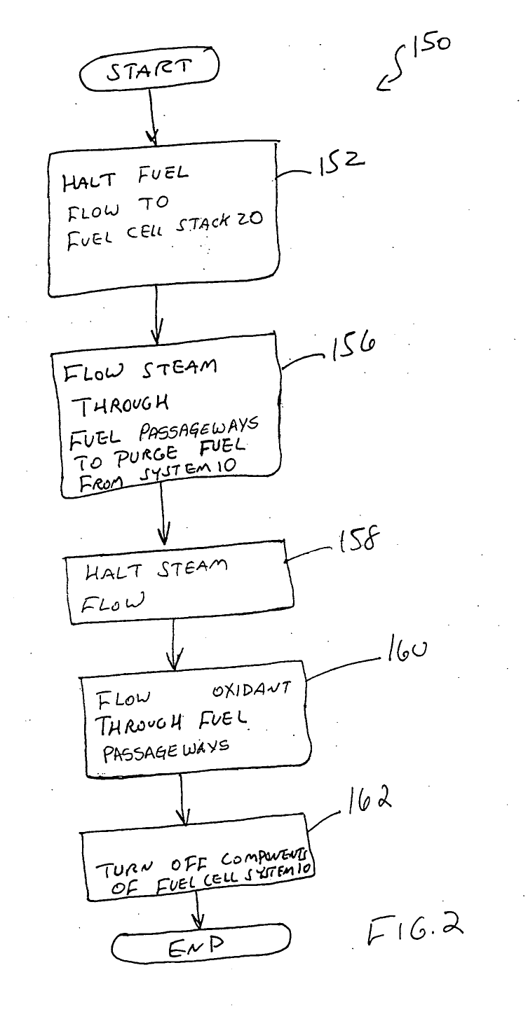

Referring to FIG. 2 in conjunction with FIG. 1, in accordance with some embodiments of the invention, the controller 90 performs a technique 150 for purposes of shutting down the fuel cell system 10. Pursuant to the technique 150, the controller 90 halts the fuel flow to the fuel cell stack 20, pursuant to block 152. Thus, in accordance with block 152, the controller 90 closes the valves 32 and 38 (for example) in accordance with some embodiments of the invention to halt the flow of fuel to the fuel cell stack 20. Next, the controller 90 flows (block 156) steam through the fuel passageways of the fuel cell system 10 to purge fuel from the system 10. Thus, when the fuel flow is cut off to the reformer 30, the reformer 30 communicates steam from the steam generator 50 through passageways of the fuel cell system 10. If the fuel cell stack 20 is not in a bypass mode, the steam propagates through the fuel passageways of the reformer 30, through the anode side of the fuel cell stack 20 and through the oxidizer 80. In accordance with some embodiments of the invention, the controller 90 monitors the temperature of the oxidizer 80 for purposes of determining when fuel has been purged from the system 10.

Next, pursuant to the technique 150, the controller 90 halts (block 158) the steam flow and flows (block 160) oxidant through the fuel passageways of the fuel cell system 10. Thus, the oxidant may be used to further purge any condensed water (due to the steam) from the fuel passageways of the system 10. It is noted that blocks 158, 160 may be performed by the controller 90 configuring the three-way valve 44 to block communication between the mixing point 39 and the inlet 48 of the reformer 30 and establish communication between the outlet 61 of the oxidant source 60 and the inlet 48. After oxidant has been used to purge the fuel passageways, then the controller 90 turns off the components of the fuel cell system 10 (pursuant to block 162) to complete shut down of the system 10.

Other variations are possible and are within the scope of the appended claims. In this regard, in accordance with some embodiments of the invention, the fuel cell stack 20 may be bypassed (by appropriately configuring the three-way valves 70 and 72) during the steam purging of the fuel passageways. This may be needed for purposes of protecting the stack if the steam would precipitate and overheat the stack. The bypass may not be necessary, in turn, for higher temperature systems. Phosphoric acid loss considerations may also require bypass of the fuel cell stack during the steam purging.

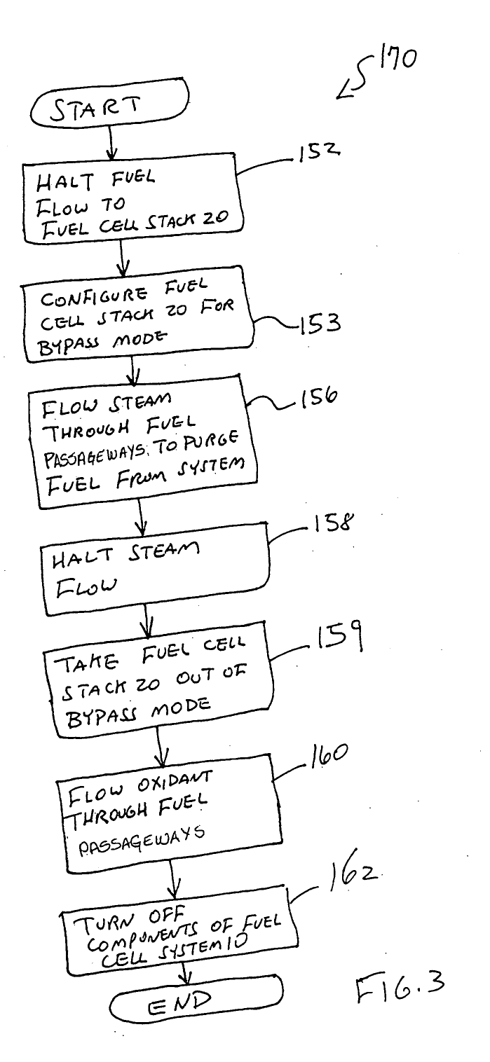

When stack bypass during the steam flow is used, the controller 90 may perform a technique 170 (FIG. 3) that is similar to the technique 150 with the following differences. Referring to FIG. 3 in conjunction with FIGS. 1 and 2, the technique 170 includes configuring (block 153) the fuel cell stack 20 for the bypass mode after halting (block 152) fuel flow to the fuel cell stack 20 and before steam is flowed through the fuel passageways to purge fuel from the system, as depicted in block 156. After the steam flow is halted (block 158), the fuel cell stack 20 is taken out of the bypass mode (pursuant to block 159) so that oxidant may be flowed (block 160) through the fuel passageways to remove fuel from the anode side of the fuel cell stack 20 and removed any condensed water from the remaining fuel passageways of the fuel cell system 10. Similar to the technique 150, after the oxidant is flowed through the fuel passageways, the components of the fuel cell system 10 are then turned off, pursuant to block 162.

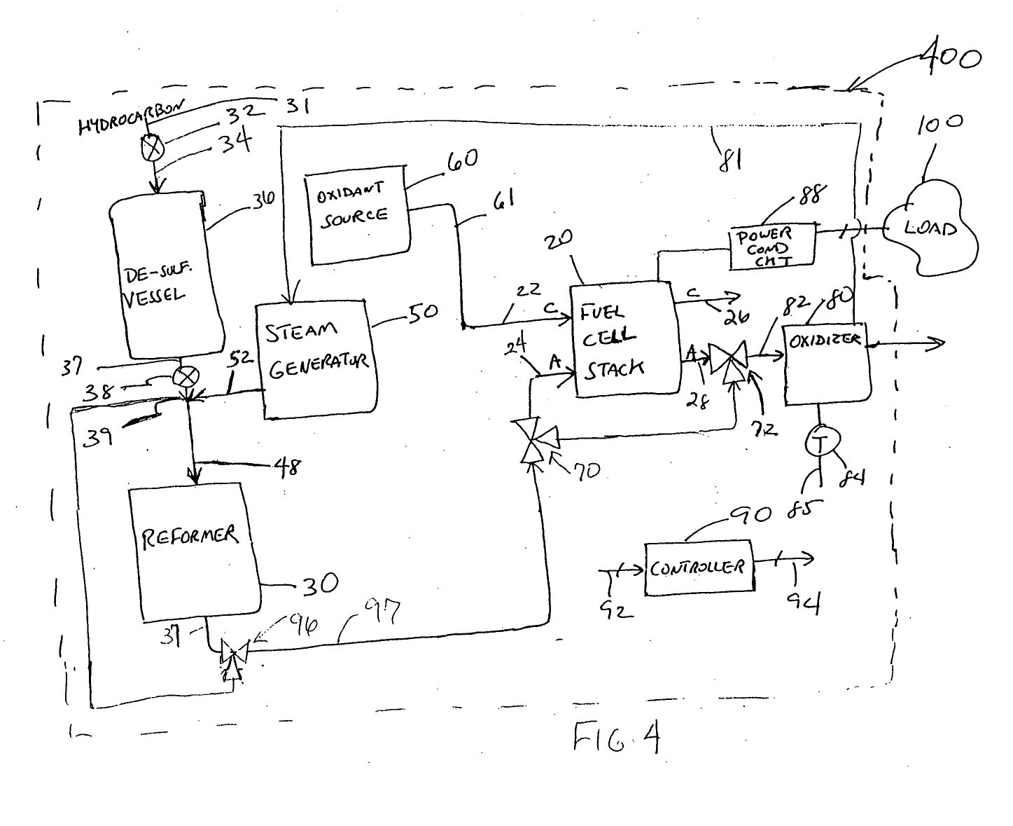

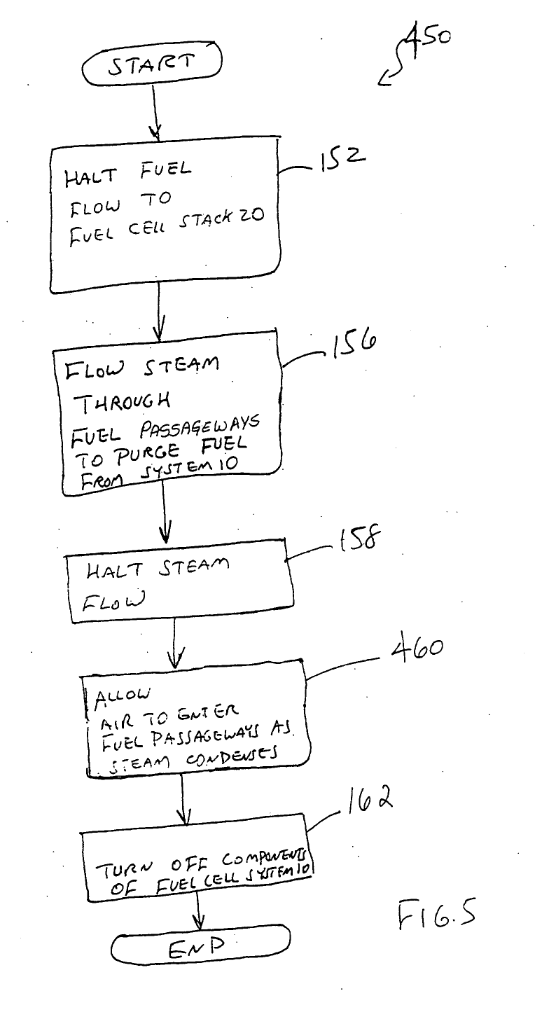

Other embodiments are within the scope of the appended claims. For example, referring to FIG. 4, in accordance with some embodiments of the invention, a fuel cell system 400 has a similar design to the fuel cell system 10 (see FIG. 1), except that the oxidant source 60 does not supply an air flow to purge fuel from the fuel passageways. Instead, the fuel cell system 400 relies on the condensation of the steam inside the fuel passageways of the fuel cell system 10 to draw air back into these passageways. In this regard, referring also to FIG. 5, in accordance with some embodiments of the invention, a technique 450 may be used, which is similar to the technique 150 with the following differences. Instead of flowing oxidant (block 160 of FIG. 2) through the fuel passageways, air is allowed (block 460 of FIG. 5) to enter the fuel passageways due to the condensation of steam.

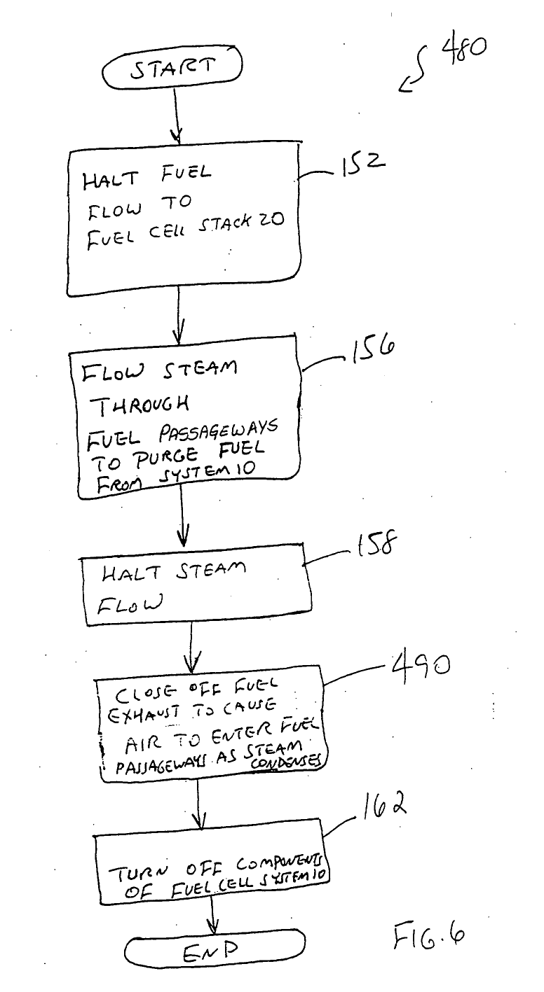

As yet another variation, in accordance with some embodiments of the invention, the fuel cell system may use a technique 400 that is depicted in FIG. 6. Referring to FIG. 6, the technique 480 is similar the technique 450, with the difference that instead of passively allowing air to enter the fuel passageways as the steam condenses (block 460 of FIG. 5), pursuant to the technique 480, the fuel exhaust is closed off (block 490 of FIG. 6) to create a vacuum that causes air to enter the fuel passageways as the steam condenses. Thus, referring to FIG. 4, as an example, the three-way valve 72 may be configured to close the flow through the anode exhaust outlet 28, in accordance with some embodiments of the invention.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method to shut down a fuel cell system, comprising:
halting a fuel flow to a fuel cell stack of the fuel cell system; and
subsequently flowing steam through fuel passageways of the fuel cell system to purge fuel from the system.

2. The method of claim 1, wherein the act of flowing comprises:
bypassing the fuel cell stack with the steam.

3. The method of claim 2, further comprising:
flowing an oxidant through the fuel cell stack to purge fuel from the fuel cell stack.

4. The method of claim 1, wherein the act of flowing comprises:
flowing the steam through an anode side of the fuel cell stack.

5. The method of claim 1, wherein the act of flowing comprises:
flowing the steam through an oxidizer of the fuel cell system.

6. The method of claim 1, wherein the act of flowing comprises:
flowing the steam through a reformer of the fuel cell system.

7. The method of claim 1, wherein the act of flowing comprises using a steam generator used during normal operation of the fuel cell system to humidify a fuel flow to the fuel cell stack.

8. The method of claim 1, further comprising:
flowing an oxidant through the fuel passageways.

9. The method of claim 8, wherein the act of flowing the oxidant occurs subsequent to the act of flowing the steam to remove water that condensed from the steam.

10. A fuel cell system comprising:
fuel passageways;
a fuel cell stack; and
a control subsystem to shut down the fuel cell system, the control subsystem adapted to:
halt a fuel flow to a fuel cell stack of the fuel cell system; and
subsequently flow steam through the fuel passageways to purge fuel from the fuel cell system.

11. The fuel cell system of claim 10, wherein the control subsystem comprises:
at least one valve to selectively bypass the fuel cell stack,
wherein the control subsystem is adapted to control the valve to bypass the stack with the steam.

12. The fuel cell system of claim 11, wherein the control subsystem is adapted to flow an oxidant through the fuel cell stack to purge fuel from the fuel cell stack.

13. The fuel cell system of claim 10, wherein the fuel passageways comprise an anode side of the fuel cell stack.

14. The fuel cell system of claim 10, wherein the fuel passageways comprise a flow path through an oxidizer of the fuel cell system.

15. The fuel cell system of claim 10, wherein the wherein the fuel passageways comprise a flow path through a reformer of the fuel cell system.

16. The fuel cell system of claim 10, further comprising:
a steam generator used during normal operation of the fuel cell system to generate the steam.

17. The fuel cell system of claim 10, wherein the control subsystem is adapted to flow an oxidant through the fuel passageways.

18. The fuel cell system of claim 17, wherein the control subsystem flows the oxidant through the fuel passageways after flowing the steam through the fuel passageways.

19. The fuel cell system of claim 10, wherein the fuel cell stack comprises PEM fuel cells.
